(19) United States
(12) Patent Application Publication
(10) Pub. No.: US 2025/0392109 A1
(43) Pub. Date: Dec. 25, 2025

(54) DEVICE FOR SUPPORTING AN OVERHEAD CABLE, SYSTEM OF AN OVERHEAD CABLE NETWORK CONFIGURED TO MANAGE AN ELECTRICAL SIGNAL COMPRISING SUCH A SUPPORT DEVICE, AND CORRESPONDING MANAGEMENT METHOD

(71) Applicant: Orange, Issy-les-Moulineaux (FR)

(72) Inventors: Loic Letondeur, CHATILLON CEDEX (FR); Christian Gregoire, CHATILLON CEDEX (FR)

(21) Appl. No.: 19/248,235

(22) Filed: Jun. 24, 2025

(30) Foreign Application Priority Data
Jun. 25, 2024 (FR) 2406842

(51) Int. Cl. H02G 7/02; H02G 7/04; H02K 35/02; H02N 2/18

(52) U.S. Cl. CPC H02G 7/02; H02G 7/04; H02K 35/02; H02N 2/18

(57) ABSTRACT

A device for supporting a first overhead cable intended to be fixed to a hollow pole is described, the device including a first counterweight intended to be disposed inside the hollow pole, and a second cable for adjusting a mechanical tension of the first cable, the second cable being anchored, at its first end, to the first cable and being fixed, at its second end, to the first counterweight. A system for an overhead cable network configured to manage an electrical signal is also described, the system including such a support device and a generator of an electrical signal under the action of a displacement of the first counterweight in the hollow pole caused by a variation in the mechanical tension of the first cable.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### TECHNICAL FIELD

The present application belongs to the general field of overhead cable connections, in particular but not exclusively, for the set-up of telecommunications networks.

The disclosed technology more specifically relates to the upkeep of the infrastructure constituting these overhead networks, such as poles and cables.

The disclosed technology also finds application in the development of the infrastructures constituting these overhead networks.

### DISCUSSION OF RELATED TECHNOLOGY

The overhead cable connection constitutes a technique commonly used for the set-up of telecommunications or electricity transmission networks, by suspending cables above the ground. This method involves the installation of poles or pylons, the laying of taut cables and possibly weather insulation and protection devices. Junction and distribution boxes facilitate the connections and the distribution of services. Although this approach offers significant advantages such as, in particular, easy access for maintenance, it also includes drawbacks.

Thus, one of these drawbacks concerns the management of the mechanical tension of the cables. Indeed, this tension must be sufficient for the cable to remain at a sufficient distance from the ground, but it must also not exceed a certain value beyond which there is a risk of tearing of the ties by means of which the cable is suspended from the poles or a risk of breakage of the cable. Such ties can consist of means for suspending the cable.

The range of values that the mechanical tension of a cable can take is determined before the laying of the latter based, among other things, on data relating to the poles from which the cable is intended to be suspended, such as the distance between two consecutive poles, their altitude, and on meteorological data such as the strength and direction of the winds in the area where the considered cable section is located, or even the temperature variations between summer and winter.

Despite these precautions taken during the installation of the cables, there is always a risk of premature wear of the overhead cables.

There is therefore a need for a solution to reduce this risk and thus extend the lifespan of the cables and poles.

### SUMMARY

The disclosed technology aims to overcome all or part of the drawbacks of other approaches, in particular those set out above, by proposing a solution that allows slowing down the aging of the cables while reducing the risks of cable breakage.

To this end, and according to a first aspect, an embodiment of the disclosed technology relates to a device for supporting a first overhead cable intended to be fixed to a hollow pole and comprising:
at least a first counterweight intended to be disposed inside said hollow pole;
at least a second cable for adjusting a mechanical tension of the first cable, the second cable being anchored, at its first end, to the first cable and being fixed, at its second end, to the first counterweight.

Such a support device allows dynamically adjusting the mechanical tension of the first cable through the use of a counterweight moving inside the pole. This device can be used for both an electricity distribution network and a telecommunications network based on the use of copper or fiber optic cables.

By dynamically adjusting the tension in the cable through the counterweight, it is possible to compensate for the variations in the mechanical tension, thus preventing the cable from slackening or breaking. Such an adjustment helps maintain a constant value of the mechanical tension of the cable, thus reducing its wear.

This support device has the advantage of requiring little space at the poles to place these counterweights since they are located inside the poles in their hollow part. Such a configuration also eliminates the need for counterweight securing means. Indeed, if the counterweights were suspended outside the poles, as is the case for railway overhead lines, their swinging could cause an oscillation of the poles, which would ultimately damage their structure.

Thus, this solution allows reducing the risks of cable damage and/or breakage without adding a safety risk to the users or to the equipment. Finally, by avoiding cable slackening and breakage, the use of a counterweight reduces the frequency of maintenance work and repair, thereby reducing the infrastructure upkeep costs.

In particular modes of implementation, the support device includes at least one tie called first tie comprising at least a first pulley in a rim of which said second cable is intended to be positioned.

The use of this pulley allows reducing the risks of wear of the second cable.

In particular modes of implementation, the support device further comprises:
at least a second counterweight intended to be disposed inside said hollow pole;
at least a third cable for adjusting a mechanical tension of the first cable, the third cable being anchored, at its first end, to the first cable and being fixed, at its second end, to the second counterweight.

In particular modes of implementation, the support device includes a second tie able to suspend the third cable from the hollow pole.

In particular modes of implementation, the second tie comprises at least a second pulley in a rim of which said third cable is intended to be positioned.

The use of this pulley allows reducing the risks of wear of the third cable and consequently the risks of wear of the first cable in both directions around the pole.

In particular modes of implementation, the first counterweight and the second counterweight have a distinct mass.

According to a second aspect, an embodiment of the disclosed technology relates to a system for an overhead cable network configured to manage an electrical signal comprising:
at least a support device according to an embodiment of the disclosed technology;
a generator of an electrical signal under the action of a displacement of said at least a first counterweight in the hollow pole caused by a variation in the mechanical tension of said first cable.

The system according to embodiments of the disclosed technology allows recovering the energy dissipated by the variations in the mechanical tension of the first cable, in addition to allowing the dynamical adjustment of this tension thanks to the use of a counterweight moving inside the pole. This system can be used both for an electricity distribution network and for a telecommunications network based on the use of copper or fiber optic cables.

The solution that is the object of embodiments of the disclosed technology advantageously allows using the movement of the counterweight generated by a variation in the value of the mechanical tension of the cable to generate an electrical signal that can be used for various purposes such as, for example, the supply of sensors or lighting devices, the supervision of the variations in the mechanical tension of the cable, etc. The energy of the electrical signal thus generated can also be stored in a battery.

In particular modes of implementation,
said at least a counterweight comprises a core made of magnetic material; and
the generator of an electrical signal comprises at least an inductance coil, disposed in the hollow pole, through which said at least a counterweight is intended to move.

In particular modes of implementation,
said at least a counterweight comprises at least an inductance coil; and
the generator of an electrical signal comprises at least a portion made of magnetic material disposed in the hollow pole, in front of which said at least a counterweight is intended to move.

Both of these implementations offer numerous advantages, in particular in terms of simplicity, energy efficiency, cost, maintenance, reliability and safety.

Indeed, these generators are sustainable and can operate reliably for long periods with minimal upkeep. In addition, the mechanical movement is directly converted into electricity, which provides high efficiency when friction and/or resistance losses are minimized.

In particular modes of implementation, the generator of an electrical signal comprises a converter of mechanical stresses into an electrical signal disposed in the hollow pole;
the displacement of said at least one counterweight in the hollow pole applying a mechanical stress to said converter.

In particular modes of implementation,
the generator of an electrical signal comprises a piezoelectric material disposed in the hollow pole;
the displacement of said at least one counterweight in the hollow pole applying a mechanical stress within said piezoelectric material.

Generating an electrical signal by means of a piezoelectric device proves to be particularly advantageous in contexts with space constraints, as is the case within a hollow pole. Indeed, piezoelectric devices are generally very compact and lightweight.

In addition, the piezoelectric materials constituting these electrical signal generation devices directly convert the mechanical energy into electrical energy without requiring complex intermediate components. This direct conversion is particularly effective for recovering the energy from vibrations, pressures, or other mechanical deformations, even small ones.

In particular modes of implementation, the system further comprises at least an accumulator of energy for said generated electrical signal.

In particular modes of implementation, the system further comprises at least a power supply able to provide one electrical signal among the following:
a generated electrical signal provided by the generator;
an electrical signal provided by the accumulator.

According to a third aspect, an embodiment of the disclosed technology relates to a method for managing an electrical signal implemented by a system according to an embodiment of the disclosed technology, the method comprising:
the generation of an electrical signal under the action of a displacement of said at least a first counterweight in the hollow pole caused by a variation in the mechanical tension of said first cable.

### BRIEF DESCRIPTION OF THE DRAWINGS

Other characteristics and advantages of the disclosed technology will emerge from the description given below, with reference to the appended drawings which illustrate one exemplary embodiment thereof without any limitation.

FIG. 1 is a schematic representation of an overhead cable network in which an embodiment of the disclosed technology is implemented.

FIG. 2A represents a pole cut along the cutting plane I-I introduced with reference to FIG. 1 according to a first embodiment of the disclosed technology.

FIG. 2B represents a pole cut along the cutting plane II-II introduced with reference to FIG. 1 according to the first embodiment of the disclosed technology.

FIG. 3 represents a pole cut along the cutting plane I-I introduced with reference to FIG. 1 according to a second embodiment of the disclosed technology.

FIG. 4A represents a system for managing an electrical signal according to a first embodiment of the disclosed technology.

FIG. 4B represents a system for managing an electrical signal according to a second embodiment of the disclosed technology.

FIG. 4C represents a system for managing an electrical signal according to a third embodiment of the disclosed technology.

### DETAILED DESCRIPTION

Embodiments of the disclosed technology aim to slow down cable aging while reducing the risks of cable breakage.

Embodiments of the disclosed technology also aim, secondly, to ensure energy autonomy without introducing new mechanical stresses at the poles from which overhead cables are suspended, which could lead to accelerated aging or breakage of these cables.

This energy autonomy allows for example supplying sensors disposed at the poles and whose function is to collect information on the mechanical behavior of these poles or of the cable fixed to them. This information facilitates the monitoring and maintenance of these infrastructures since, by contributing in particular to the determination of a level of mechanical fatigue of the cable and/or poles, it allows planning maintenance operations.

This energy autonomy also allows supplying electrical energy to other devices such as public lighting devices, etc.

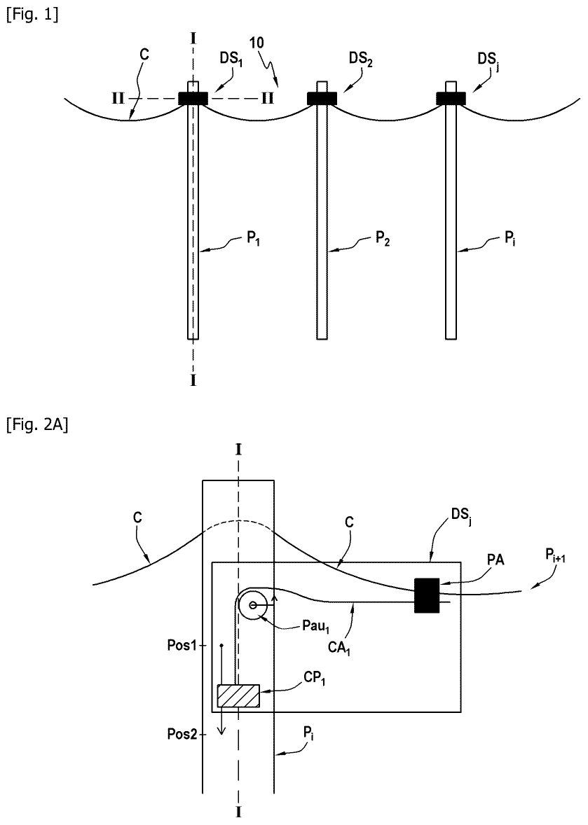

FIG. 1 is a schematic representation of an overhead cable network 1 in which an embodiment of the disclosed technology can be implemented. Although described with reference to a telecommunications network, the disclosed technology also finds application in overhead electricity transmission networks.

Such an overhead cable network 1 comprises N poles Pᵢ with i∈{1; . . . ; N}. The poles Pᵢ are hollow poles made of composite materials such as fiberglass. These poles Pi made of composite material are lighter than the conventional wooden poles, and they are also easier to install and less expensive.

Despite their light weight, the poles Pᵢ show high resistance to all types of loads. Furthermore, they are considered passive safety elements because, in the event of a collision with a vehicle, they collapse without endangering the lives of passengers.

A cable C is fixed to the poles Pᵢ by means of ties DSⱼ, with j∈{1; . . . ; M} where M is greater than or equal to N. A single pole Pᵢ may include multiple ties DSⱼ. These ties, called support devices DSⱼ in the rest of the document, will be discussed in more detail later in the present document.

Such a cable C can be either a cable intended for the transmission of electricity or a cable intended for the transmission of telecommunications signals, such as copper or fiber optic cables.

This FIG. 1 also represents a first cutting plane I-I parallel to the pole Pᵢ and a second cutting plane II-II perpendicular to the first cutting plane.

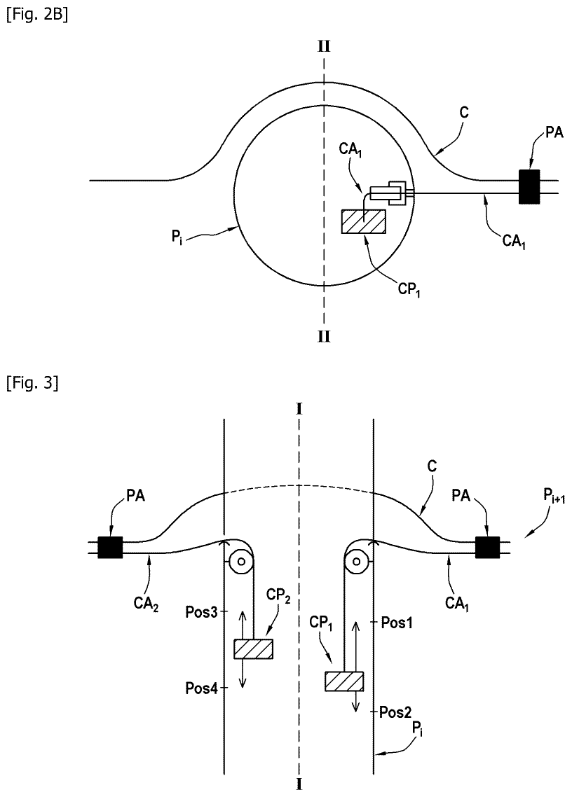

FIG. 2A represents a pole Pᵢ cut along the cutting plane I-I introduced with reference to FIG. 1 according to a first embodiment of the disclosed technology. In this figure, the tie by means of which the cable C is suspended from the pole Pᵢ is not represented so as not to overload the figure.

This FIG. 2A shows in close-up and in section the upper part of the pole Pᵢ on which a support device DSⱼ schematically represented by a rectangle is fixed.

The support device DSⱼ comprises a pulley Pour fixed on an inner surface of the pole Pᵢ in the rim of which a cable CA₁ for adjusting a mechanical tension of the cable C is positioned. A first end of the cable CA₁ is anchored to the cable C by means of an anchoring clamp PA while a second end of the cable CA₁ is fixed to a counterweight CP₁ located inside the pole Pᵢ.

Thus, when the mechanical tension of the cable C varies, this variation is transmitted to the cable CA₁ to which it is anchored. This variation in the mechanical tension of the cable C causes, via the cable CA₁ and the pulley Pour in which it is positioned, a movement of the counterweight CP₁ which oscillates vertically between a first position Pos1 and a second position Pos2. The amplitude of this oscillating movement is a function of the value of the variation in the mechanical tension of the cable C.

FIG. 2B, for its part, represents the pole Pᵢ cut along the cutting plane II-II introduced with reference to FIG. 1 according to the first embodiment of the disclosed technology.

This FIG. 2B shows the pulley Pou fixed on the internal surface of the pole Pᵢ and the cable CA₁ positioned in the rim of the pulley. The pulley Pour overhangs the counterweight CP₁ fixed to the second end of the cable CA₁ and disposed inside the pole Pᵢ. The cable C, for its part, goes around the outside of the pole Pᵢ.

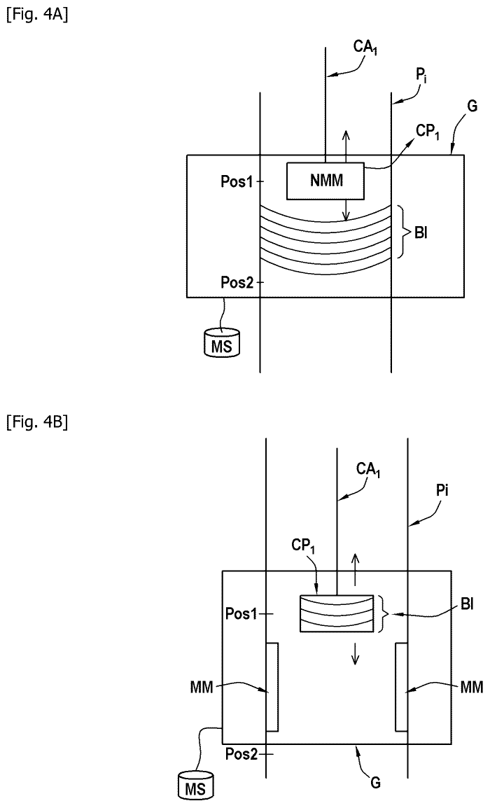

FIG. 3 represents a pole Pᵢ cut along the cutting plane I-I introduced with reference to FIG. 1 according to a second embodiment of the disclosed technology.

This FIG. 3 shows in close-up and in section the upper part of the pole Pᵢ on which two support devices DSⱼ and DSⱼ₊₁ schematically represented by a rectangle are fixed.

The first support device DSⱼ comprises a pulley Pou₁ fixed on an inner surface of the pole Pᵢ in the rim of which a cable CA₁ for adjusting a mechanical tension of the cable C is positioned. A first end of the CA₁ cable is anchored to the cable C by means of an anchoring clamp PA while a second end of the cable CA₁ is fixed to a counterweight CP₁ located inside the pole Pᵢ.

The second support device DSⱼ₊₁ comprises a pulley Pou₂ fixed on an inner surface of the pole Pᵢ in the rim of which a cable CA₂ for adjusting a mechanical tension of the cable C is positioned. A first end of the cable CA₂ is anchored to the cable C by means of an anchoring clamp PA while a second end of the cable CA₂ is fixed to a counterweight CP₂ located inside the pole Pᵢ.

Thus when the mechanical tension of the cable C varies, this variation is transmitted to the cable CA₁ and to the cable CA₂ to which it is anchored. This variation in the mechanical tension of the cable C causes, via the cable CA₁ and the pulley Pou₁ in which it is positioned, a movement of the counterweight CP₁ which oscillates vertically between a first position Pos1 and a second position Pos2. The amplitude of this oscillating movement is a function of the value of the variation in the mechanical tension of the cable C.

Similarly, this variation in the mechanical tension of the cable C causes, via the cable CA₂ and the pulley Pou₂ in which it is positioned, a movement of the counterweight CP₂ which oscillates vertically between a first position Pos3 and a second position Pos3, which may or may not be identical to the positions Pos1 and Pos2 associated with the first counterweight CP₁. The amplitude of this oscillating movement is a function of the value of the variation in the mechanical tension of the cable C.

In this second embodiment, the two counterweights CP₁ and CP₂ may have an identical mass or a different mass. The value of the mass of each of the counterweights CP₁ and CP₂ depends on the value of the mechanical tension of the cable section C to which the cable CA₁ and the cable CA₂ are respectively anchored. Indeed, two sections of the same cable C can have different mechanical stresses that influence the value of the mechanical tension calculated prior to the installation of the cable C.

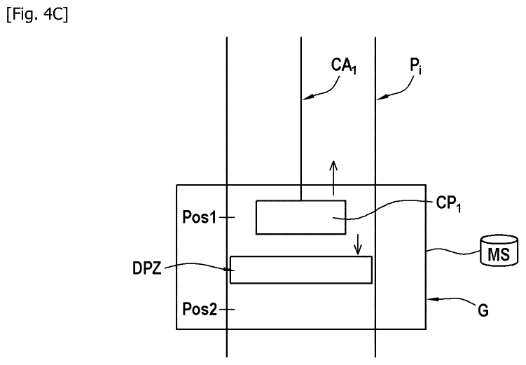

FIG. 4A represents a system for managing an electrical signal according to a first embodiment of the disclosed technology.

This FIG. 4A shows in close-up and in section the lower part of the pole Pi, inside which a counterweight CP₁ is suspended, cut along the cutting plane I-I introduced with reference to FIG. 1 as well as a generator G of an electrical signal schematically represented by a rectangle. In this first embodiment, the generator G is an induction generator based on the use of an inductance coil and of a core made of magnetic material.

In this first embodiment, an inductance coil BI is disposed inside the pole Pᵢ against the wall between the positions Pos1 and Pos2 between which the counterweight CP₁ moves when a variation in the mechanical tension of the cable C occurs. In order to generate an electrical signal by induction, the counterweight CP₁ comprises a core made of magnetic material NMM. Thus, the displacement of the counterweight CP₁ through the inductance coil BI generates an electrical signal.

In one variant of implementation, the system comprises a second counterweight CP₂ also comprising a core made of magnetic material NMM. In this implementation, the inductance coil BI is disposed inside the pole Pᵢ against the wall both between the positions Pos1 and Pos2 and between the positions Pos3 and Pos4 between which the counterweight CP₂ moves when a variation in the mechanical tension of the cable C occurs. Thus, the two counterweights contribute to generating an electrical signal.

FIG. 4B represents a system for managing an electrical signal according to a second embodiment of the disclosed technology.

This FIG. 4B shows in close-up and in section the lower part of the pole Pᵢ inside which a counterweight CP₁ is suspended, cut along the cutting plane I-I introduced with reference to FIG. 1, as well as a generator G of an electrical signal schematically represented by a rectangle. In this second embodiment, the generator G is an induction generator based on the use of an inductance coil and of a core made of magnetic material.

In this second embodiment, a magnetic material MM is disposed inside the pole Pᵢ against the wall between the positions Pos1 and Pos2 between which the counterweight CP₁ moves when a variation in the mechanical tension of the cable C occurs. In order to generate an electrical signal by induction, the counterweight CP₁ comprises an inductance coil BI. Thus, the displacement of the counterweight CP₁ through the magnetic material MM generates an electrical signal.

In one variant of implementation, the system comprises a second counterweight CP₂, also comprising an inductance coil BI. In this implementation, the magnetic material MM is disposed inside the pole Pᵢ against the wall both between the positions Pos1 and Pos2 and between the positions Pos3 and Pos4, between which the counterweight CP₂ moves when a variation in the mechanical tension of the cable C occurs. Thus, the two counterweights contribute to generating an electrical signal.

FIG. 4C represents a system for managing an electrical signal according to a third embodiment of the disclosed technology.

This FIG. 4C shows in close-up and in section the lower part of the pole Pᵢ inside which a counterweight CP₁ is suspended, cut along the cutting plane I-I introduced with reference to FIG. 1, as well as a generator G of an electrical signal schematically represented by a rectangle. In this third embodiment, the generator uses the principle of converting a mechanical stress into an electrical signal, such as the principle of piezoelectricity, to generate an electrical signal.

In this third embodiment, a disk made of piezoelectric material DPZ is disposed inside the pole Pᵢ at the lowest at the position Pos2 to which the counterweight CP₁ moves when a variation in the mechanical tension of the cable C occurs.

Indeed, in order to generate an electrical signal, the counterweight CP₁ must exert sufficient pressure on the piezoelectric material constituting the piezoelectric disk DPZ. For this, the piezoelectric disk DPZ is disposed above the position Pos2 representing a lower extreme position of the counterweight CP₁ in the pole Pᵢ.

In one variant of implementation, the system comprises a second counterweight CP₂. In this implementation, the piezoelectric disk DPZ is disposed inside the pole Pᵢ at a position Pos that allows both the counterweight CP₁ and the counterweight CP₂ to exert sufficient pressure on the piezoelectric material constituting the piezoelectric disk DPZ.

Thus, this position Pos is located above those of the two positions Pos2 or Pos4 which is closest to the top of the pole Pᵢ, thus ensuring that each of the two counterweights CP₁ and CP₂ exerts sufficient pressure on the piezoelectric disk DPZ to generate an electrical signal.

This third embodiment can be implemented in conjunction with the first or second embodiment of the management system.

In variants of implementations, the generator G is electrically connected to electrical energy storage means MS represented in FIGS. 4A to 4C. Such electrical energy storage means MS can take the form of an accumulator.

Finally, in variants of implementation, the system for managing an electrical signal comprises a power supply (not represented in the figures) able to provide an electrical signal to equipment located in the vicinity of the pole Pᵢ. The electrical signal provided by this power supply may be the electrical signal directly generated by the generator G or an electrical signal provided by the storage means MS.

The electrical signal thus delivered may then supply sensors intended to monitor the mechanical tension of the cable C, public lighting means, etc.

1. A device for supporting a first overhead cable intended to be fixed to a hollow pole, the device comprising:
at least a first counterweight intended to be disposed inside said hollow pole;
at least a second cable for adjusting a mechanical tension of the first cable, the second cable being anchored, at its first end, to the first cable and being fixed, at its second end, to the first counterweight.

2. The device of claim 1 wherein the support device includes a first tie comprising at least a first pulley, said second cable intended to be positioned in a rim of said first pulley.

3. The device of claim 1, further comprising:
at least a second counterweight intended to be disposed inside said hollow pole;
at least a third cable for adjusting a mechanical tension of the first cable, the third cable being anchored, at its first end, to the first cable and being fixed, at its second end, to the second counterweight.

4. The device of claim 3, wherein the support device includes a second tie able to suspend the third cable from the hollow pole.

5. The device of claim 4, wherein the second tie comprises at least a second pulley, said third cable intended to be positioned in a rim of said second pulley.

6. The device of claim 3, wherein the first counterweight has a first mass, and wherein the second counterweight has a second mass distinct from the first mass.

7. A system for an overhead cable network configured to manage an electrical signal, the system comprising:
the support device of claim 1; and
a generator of an electrical signal under the action of a displacement of said at least a first counterweight in the hollow pole caused by a variation in the mechanical tension of said first cable.

8. The system of claim 7 wherein:
said at least one counterweight comprises a core made of magnetic material; and
the generator of an electrical signal comprises at least an inductance coil, disposed in the hollow pole, through which said at least one counterweight is intended to move.

9. The system of claim 7 wherein:
said at least one counterweight comprises at least an inductance coil; and
the generator of an electrical signal comprises at least a portion made of magnetic material disposed in the hollow pole, in front of which said at least one counterweight is intended to move.

10. The system of claim 7, wherein the generator of an electrical signal comprises a converter of mechanical stresses into an electrical signal disposed in the hollow pole, the displacement of said at least one counterweight in the hollow pole applying mechanical stress to said converter.

11. The system of claim 7, wherein the generator of an electrical signal comprises a piezoelectric material disposed in the hollow pole, the displacement of said at least one counterweight in the hollow pole applying a mechanical stress within said piezoelectric material.

12. The system of claim 7, further comprising at least an accumulator of energy for said generated electrical signal.

13. The system of claim 12, further comprising at least a power supply able to provide one electrical signal among the following:
a generated electrical signal provided by the generator; and
an electrical signal provided by the accumulator.

14. A method for managing an electrical signal implemented by the system of claim 7, the method comprising:
generating an electrical signal under the action of a displacement of said at least a first counterweight in the hollow pole caused by a variation in the mechanical tension of said first cable.
